(19) United States
(12) Patent Application Publication
(10) Pub. No.: US 2012/0248309 A1
(43) Pub. Date: Oct. 4, 2012

(54) SPECIMEN GRID HOLDER AND FOCUSED ION BEAM SYSTEM OR DUAL BEAM SYSTEM HAVING THE SAME

(75) Inventors: SAN LIN LIEW, TAIPEI CITY (TW); YU-TZU HUANG, TAICHUNG CITY (TW)

(73) Assignee: INOTERA MEMORIES, INC., TAOYUAN COUNTY (TW)

(21) Appl. No.: 13/226,536

(22) Filed: Sep. 7, 2011

(30) Foreign Application Priority Data
Apr. 1, 2011 (TW) 100111569

(51) Int. Cl. G21K 5/08; G01N 23/00

(52) U.S. Cl. 250/307; 250/440.11; 250/441.11

(57) ABSTRACT

A specimen grid holder includes a base and two holding members disposed thereon. Each holding member has at least one inserting portion and at least one holding portion formed adjacently. The specimen grid can be inserted into the inserting portion and moved to the holding portion for securement. The two holding members can be used to secure specimens at different orientations for analyses.

### BACKGROUND OF THE INVENTION

1. Field of the Invention

The instant disclosure relates to a holding device and a focused ion beam system or dual beam system having the same; more particularly, to a specimen grid holder and a focused ion beam system or dual beam system having the same.

2. Description of Related Art

As manufacturing techniques of semiconductors continue to advance, the feature sizes of the semiconductors are becoming smaller accordingly. During the manufacturing stage, electron microscopes are widely used to analyze and monitor the structural and compositional characteristics of the semiconductor thin films. In particular, transmission electron microscope (TEM) has become one of the most important tools to serve the production line monitoring purpose. This is because TEM is capable of carrying out both atomic level structural inspection as well as providing reliable atomic level compositional information.

There are two sample viewing orientations used in TEM analysis, namely the cross-sectional view and plan view. While cross-sectional view is more commonly used, plan view inspection can be very useful especially when inspection over a broader area is needed. For example, in failure analysis, one would typically start with a plan view analysis to localize the fail site before proceeding to a more site specific analysis through a cross-sectional view inspection.

To prepare a TEM specimen, regardless of a cross-sectional view TEM specimen or a plan view TEM specimen, the specimen is subjected to a thinning process done by a broad beam ion miller or a focused ion beam (FIB) system (also generally known as dual beam system) to reach electron transparent thickness. Sample thinning using a FIB equipped with nanometer level “slice-and-view” capability has become more favorable and often necessary if the area of interest is of site specific. In particular, the FIB in-situ lift-out technique has proven to be an important TEM sample preparation technique as the operations or procedures involved are more controllable and therefore allowing a higher sample preparation success rate.

However, note that the FIB is constructed such that the specimen grid is placed in an up-right position suitable for cross-sectional TEM specimen preparation only. In other words, the grid cannot be utilized directly to prepare a TEM plan view specimen.

To address the above issue, an additional attachment or a platform needs to be added to the FIB for adjusting the grid to a leveled position, such that a specimen for plan-view examination can be prepared too.

The drawback is: this platform is typically FIB model dependence and therefore cannot be used universally in all FIBs. Plus, after the platform is added, the FIB chamber needs to be re-vacuumed whenever such platform is used; hence prolonging the TEM sample preparation time. Even worse, the platform has limited movement control, i.e. not “rotatable” and therefore hampers the precision final specimen thinning operation.

### SUMMARY OF THE INVENTION

One aspect of the instant disclosure is to provide a specimen grid holder and focused ion beam system (or dual beam system) having the same. The specimen grid holder can secure the specimen grid at different orientations, allowing both cross-sectional as well as plan-view TEM sample preparation. Therefore, no additional attachment or platform which has limited movement control is required for the focused ion beam system for simplicity.

The specimen grid holder comprises: a base; a first holding member disposed on the base, wherein the first holding member has at least one first inserting portion for inserting a specimen grid along the direction of a first rotating axis, plus at least one first holding portion formed adjacently to the first inserting portion, wherein after the specimen grid is inserted into the first inserting portion, the specimen grid is slid to the first holding portion to be secured by the first holding member; and a second holding member disposed on the base, wherein the second holding member has at least one second inserting portion for inserting the specimen grid along the direction of a second rotating axis, plus at least one second holding portion formed adjacently to the second inserting portion, wherein after the specimen grid is inserted into the second inserting portion, the specimen grid is slid to the second holding portion to be secured by the second holding member.

The focused ion beam system, which is used for preparing a TEM specimen, comprises: a vacuumed chamber formed thereon; an electron source disposed in the vacuumed chamber; a support stand disposed in the vacuumed chamber; a specimen grid holder disposed on the support stand, wherein the specimen grid holder comprises a base, with a first holding member disposed on the base, wherein the first holding member has at least one first inserting portion for inserting a specimen grid along the direction of a first rotating axis, plus at least one first holding portion formed adjacently to the first inserting portion, wherein after the specimen grid is inserted into the first inserting portion, the specimen grid is slid to the first holding portion to be secured by the first holding member; and a second holding member disposed on the base, wherein the second holding member has at least one second inserting portion for inserting the specimen grid along the direction of a second rotating axis, plus at least one second holding portion formed adjacently to the second inserting portion, wherein after the specimen grid is inserted into the second inserting portion, the specimen grid is slid to the second holding portion to be secured by the second holding member.

The instant disclosure has the following advantages. Namely, the specimen grid holder can accommodate specimen grid at different orientations. The examiner can instinctively and quickly secure the specimen grid thereon. In addition, the specimen grid holder can be used with the focused ion beam system for cross-sectional or plan-view imaging/analysis and for preparing a TEM specimen. Thereby, the issues due to addition of the platform done conventionally can be avoided.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view of a specimen grid holder of the instant disclosure.

FIG. 2A is a perspective view of a first holding member of the specimen grid holder of the instant disclosure.

FIG. 2B is an enlarged view for part of the first holding member of the specimen grid holder of the instant disclosure.

FIG. 3A is a perspective view of a first holding member of the specimen grid holder for another embodiment of the instant disclosure.

FIG. 3B is an enlarged view for part of the first holding member of the specimen grid holder of FIG. 3A.

FIG. 4 is a perspective view of a first holding member of the specimen grid holder of yet another embodiment of the instant disclosure.

FIG. 5A is a schematic view of using the specimen grid holder with a focused ion beam system stage cassette of the instant disclosure.

FIG. 5B is an enlarged view for a portion of part A of FIG. 5A.

### DETAILED DESCRIPTION OF PREFERRED EMBODIMENTS

The instant disclosure provides a specimen grid holder and a focused ion beam system (or dual beam system) having the same. The specimen grid holder can secure a specimen grid having semiconductor type specimen thereon onto the focused ion beam system. The specimen grid holder can be directly used for cross-sectional or plan-view imaging/analysis and for preparing a TEM specimen. The semiconductor type specimen can be an etched product, a metal-deposited product, etc.

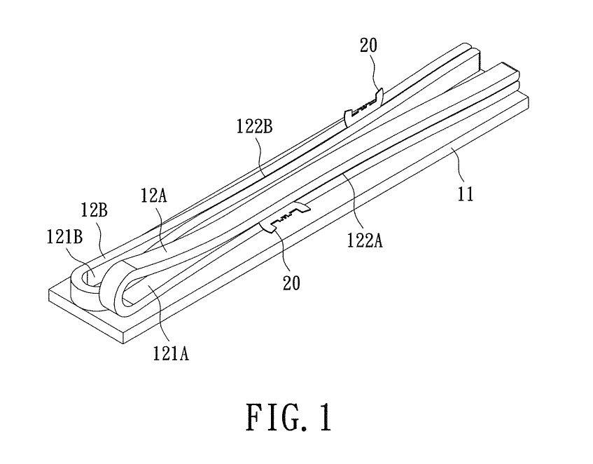

Please refer to FIG. 1. The specimen grid holder comprises a base 11 and a first holding member 12A and a second holding member 12B both disposed thereon. For the instant embodiment, the first and second holding members 12A and 12B are disposed correspondingly on the base 11. Preferably, conductive adhesives such as aluminum gel or aluminum tape are used to secure the first and second holding members 12A and 12B conductively onto the base 11. The reason is to prevent the accumulation of electrons on the specimen grid 20 so that reliable analysis can be carried out. Please note that for in-situ lift-out TEM sample preparation, the mentioned specimen grid 20 would typically include a metal grid having protruded structure. A small chuck having area of interest for analysis is attached onto the metal grid by in-situ lift-out method. Lastly, for TEM analysis, the area of interest is thinned to electron transparent to produce the so-called TEM lamella. For simplicity, the interest chuck and lamella will be not illustrated on the drawings.

Also, the first and second holding members 12A and 12B serve to secure the specimen grid 20 having lamella thereon at different orientations. Such capability allows the lamella on the specimen grid 20 to be processed and treated more easily (e.g. thinning) by adjusting its rotational axes. For the instant embodiment, the first and second holding members 12A and 12B are secured onto the base 11 at different directions. More specifically, the first and second holding members 12A and 12B are mounted perpendicularly to each other.

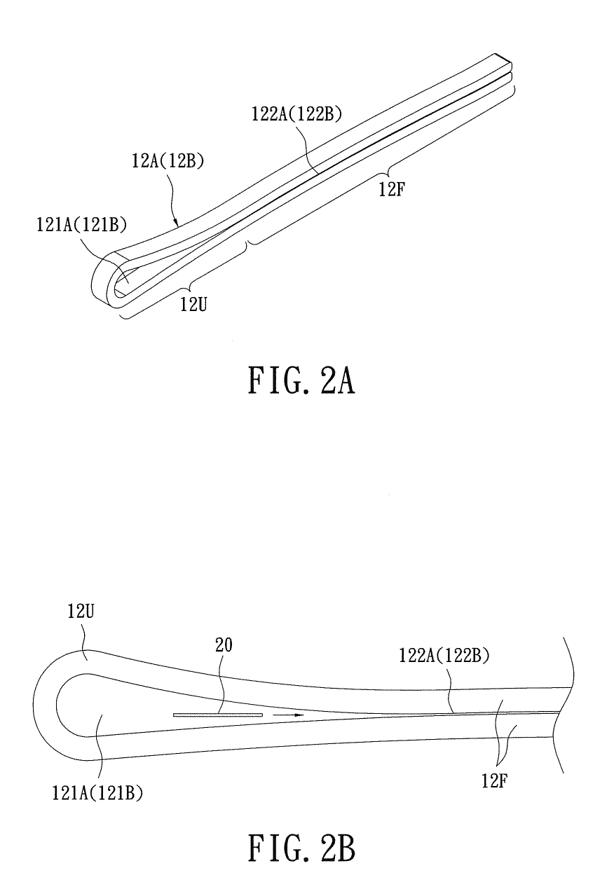

Structural descriptions of the first and second holding members 12A and 12B are explained below. For the instant embodiment, the first and second holding members 12A and 12B may be identical to each other. For explaining purpose, the first holding member 12A is described in details below. Please refer to FIGS. 1, 2A, and 2B. The first holding member 12A has at least one eye-like first inserting portion 121A and at least one first holding portion 122A formed by extending slenderly from the first inserting portion 121A. For the instant embodiment, the first holding member 12A has one first inserting portion 121A and one first holding portion 122A. In use, the examiner can place the specimen grid 20 into the first inserting portion 121A, followed by sliding the specimen grid 20 to the first holding portion 122A for securement. Afterwards, the secured specimen grid 20 can be subjected to additional treatments or processing.

For the instant disclosure, the first and second holding members 12A and 12B are not restricted structurally to a single configuration. Any holding member that has an inserting portion and a holding portion is under the scope of instant disclosure. For the instant embodiment, both first and second holding members 12A and 12B are slenderly shaped, made of conductive material such as copper or aluminum, and folded backward. For example, the first holding member 12A is folded backward in forming a U shape, defined by a folded portion 12U and two extending portions 12F. The folded portion 12U forms a narrowing receiving space that performs as the aforementioned first inserting portion 121A. A slender opening or gap is defined between the two extending portions 12F (for example, two straight arms), wherein the slender opening, which performs as the aforementioned first holding portion 122A, communicates to the preceding receiving space. In use, the specimen grid 20 is first disposed into the receiving space, i.e., the first inserting portion 121A. Then, the specimen grid 20 is slid toward the narrower opening, i.e., the first holding portion 122A. The sliding direction is illustrated by the arrow shown in FIG. 2B. The specimen grid 20 is eventually grabbed in between the two extending portions 12F. Preferably, the width of the opening defined by the extending portions 12F is smaller or equal to the thickness of the specimen grid 20. When the specimen grid 20 is slid into the first holding portion 122A, the specimen grid 20 is grabbed tightly in between the extending portions 12F due to the resilient force thereof.

Likewise, the second holding member 12B is also U-shaped, wherein the second inserting portion 121B is defined by the receiving space as described above for insertion of the specimen grid 20. The second holding portion 122B is defined by the slender opening between the two extending portions 12F for grabbing and securing the specimen grid 20. Since the second holding member 12B operates identically as the first holding member 12A, the same details are not repeated herein. Accordingly, the specimen grid 20 may be alternatively secured on the first holding member 12A and the second holding member 12B for the specimen preparation.

Please refer back to FIG. 1. When the specimen grid holder of the instant disclosure is used along with the focused ion beam system, the first and second holding members 12A and 12B disposed on the base 11 are available for receiving specimen grids 20 oriented at different directions for in-situ lift-out procedure on the specimen grid 20. Thereby, the user can carry out cross-sectional or plan-view TEM sample preparation on the specimen grid 20 for TEM analysis.

More specifically, the user can place the specimen grid 20 levelly (first rotational axis) into the first inserting portion 121A of the first holding member 12A, and slide the specimen grid 20 to the first holding portion 122A for securement.

On the other hand, the user can also place the specimen grid 20 perpendicularly (second rotational axis) into the second inserting portion 121B of the second holding member 12B, and slide the specimen grid 20 to the second holding portion 122B for securement.

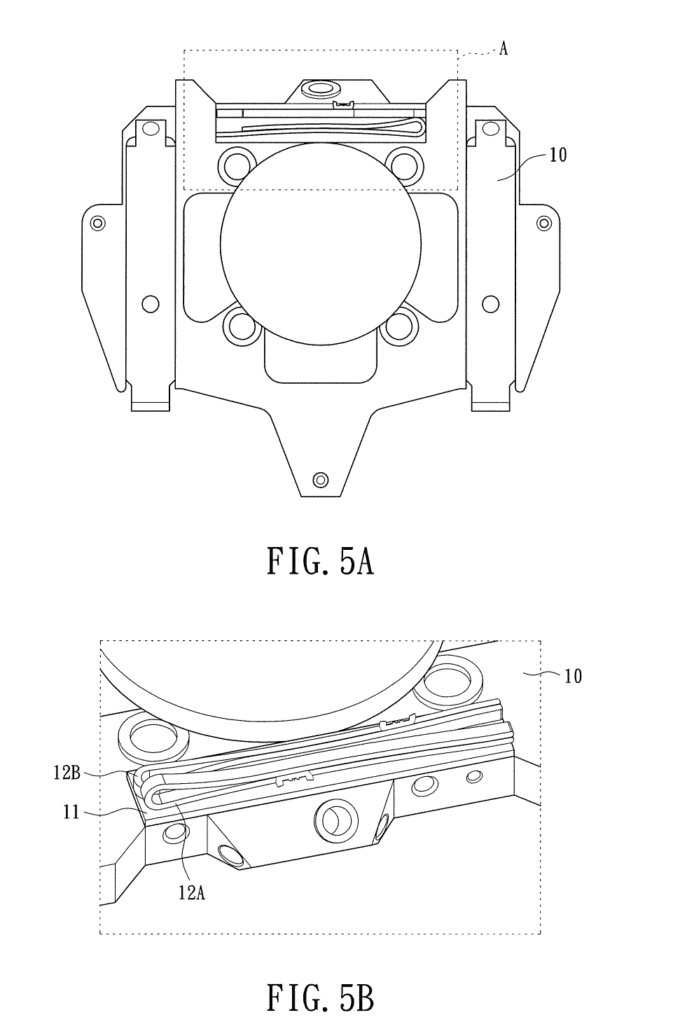

In use, the specimen grid holder of the instant disclosure can be used with a focused ion beam system. For such application, detailed explanation is given below. The focused ion beam system has a vacuumed chamber (not shown) formed therein, an electron source (not shown) disposed in the vacuumed chamber, a stage cassette or support stand 10 disposed in the vacuumed chamber, and a signal receiver (not shown) disposed in the vacuumed chamber. Other accessories may include electromagnetic lens, etc. Since the focused ion beam system is not the main focus of the instant disclosure, therefore is not described in details herein. Meanwhile, the specimen grid holder of the instant disclosure is secured onto the aforementioned support stand 10 (as shown in FIGS. 5A and 5B). The support stand 10 can be rotated. Hence, the user can utilize the support stand 10 to rotate the specimen grid holder.

As mentioned previously, one can use the specimen grid holder on the support stand 10 to perform cross-sectional or plan-view preparation of the lamella. Please refer to FIG. 1. When one wishes to prepare a cross sectional TEM sample using the in-situ lift-out method, a specimen grid 20 for lift-out purpose (typically a metal grid with protruded structure) is first inserted into the second insertion portion 121B of the second holding member 12B, and slide the specimen grid 20 to the second holding portion 122B for securement. A small chuck is partially separated from the surface of a supplied test piece (typically a semiconductor wafer piece) by FIB milling. Then, the chuck is physically attached to a probe needle via FIB-assisted deposition (typically Pt deposition). The chuck is then completely separated from the supplied test piece by FIB cutting. Next, with the chuck on it, the probe needle is manipulated towards the specimen grid 20 available at the second holding portion 122B. The chuck is then attached to the specimen grid 20 via FIB assisted deposition, followed by separation from the probe needle by FIB-milling. At this point, the in-situ lift-out is completed whereby the chuck has been successfully transferred to the specimen grid 20. The chuck is then final-thinned to reach electron transparent to produce the so-called TEM lamella (i.e., the TEM specimen). Lastly, the specimen grid 20 is removed from the specimen grid holder and transferred to a TEM apparatus for cross-sectional analysis.

To prepare a plan-view TEM sample, the same lift-out method can be used. However, instead of having the metal specimen grid 20 placed at the second holding portion 122B of the second holding member 12B, the specimen grid 20 for the lift-out method should now be placed at the first holding portion of 122A of the first holding member 12A. Then, the same lift-out procedure is used to transfer the chuck to the specimen grid 20. After the chuck is successfully attached to the specimen grid 20, the specimen grid 20 should be removed from the first holding member 12A and then placed to the second holding member 12B (i.e., clamped in the second holding portion 122B) for final sample thinning. Lastly, the specimen grid 20 is removed from the specimen grid holder and transferred to a TEM apparatus for plan-view analysis.

Thereby, the specimen grid holder of the instant disclosure can provide specimen preparations in different orientations and observations for cross-sectional and plan-view analyses. Thus, the conventional apparatus of securing the specimen grid 20 can be replaced accordingly.

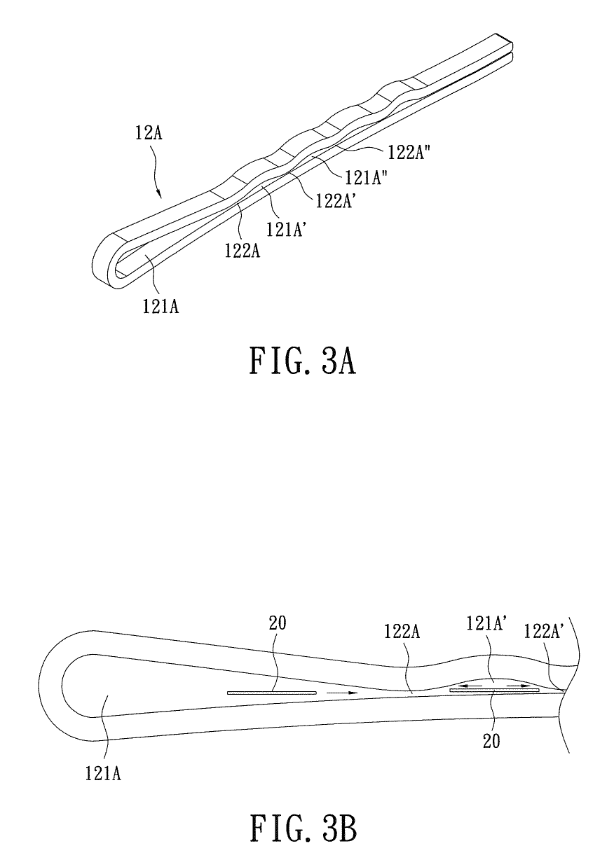

Please refer to FIGS. 3A and 3B, which relate to a specimen grid holder for another embodiment of the instant disclosure. Please note, only the first holding member 12A is illustrated here. Made of conductive material, the first holding member 12A is folded with a U-shaped structure formed slenderly. One of the two extending portions 12F may be a wave-shaped ami, and the other one of the two extending portions 12F may be a straight arm. A plurality of receiving spaces are formed by the wave-shaped arm and the straight arm of the U-shaped structure in performing a plurality of first inserting portions 121A, 121A′, and 121A″. Also, a plurality of narrow openings, which communicates with the aforementioned receiving spaces, is formed by the wave-shaped arm and the straight arm of the U-shaped structure. These narrow openings may perform as a plurality of first holding portions 122A, 122A′, and 122A″. Thereby, the user has the option of securing the specimen grid 20 at the holding portion on either side of the inserting portion. For example, with respect to the first inserting portion 121A′, the first holding portions 122A and 122A′ are formed on the respective side of the first inserting portion 121A′. So, when the user inserts the specimen grid 20 into the first inserting portion 121A′, the user can slide the specimen grid 20 selectively into the first holding portion 122A or 122A′. Alternatively, a plurality of specimen grids 20 can be secured to the first holding portions 122A, 122A′, and 122A″ respectively of the U-shaped structure for analyzing multiple specimens.

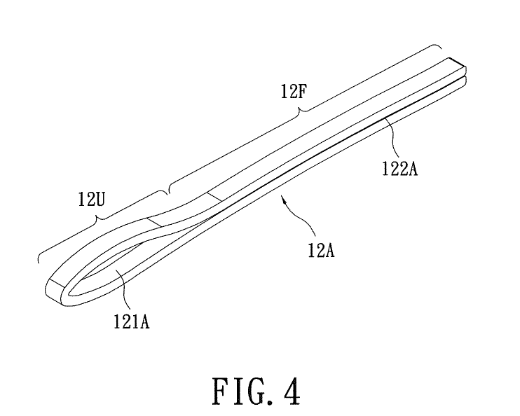

Please refer to FIG. 4, which relates to a specimen grid holder for yet another embodiment of the instant disclosure. Only the first holding member 12A is illustrate herein for explaining purpose. Made of conductive material, the first holding member 12A is folded in forming a U-shaped structure slenderly. However, the receiving space formed by the folded portion 12U of the U-shaped structure is wider longitudinally versus the preceding embodiments. Thereby, the larger sized specimen grid 20 can be used. In summary, the specimen grid holder of the instant disclosure can be varied structurally to fit the needs of the application.

Based on the above descriptions, the instant disclosure has the following advantages. Namely, the specimen grid holder of the instant disclosure is structurally simple and easy to use. Also, by securing the specimen though the resilient force of the holding member, damages due to the conventional bolting method can be avoided. Furthermore, the specimen grid holder can be used with the focused ion beam system to prepare the specimen.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A specimen grid holder for semiconductor specimen grids, comprising:
a base;
a first holding member disposed on the base, wherein the first holding member has at least one first inserting portion for inserting a specimen grid along a first rotational axis and at least one first holding portion formed adjacent to the first inserting portion, wherein the inserted specimen grid is slid to the first holding portion for securement; and
a second holding member disposed on the base, wherein the second holding member has at least one second inserting portion for inserting the specimen grid along a second rotational axis and at least one second holding portion formed adjacent to the second inserting portion, wherein the inserted specimen grid is slid to the second holding portion for securement.

2. The specimen grid holder of claim 1, wherein the first holding member and the second holding member are slenderly shaped, made of conductive material, and folded backward.

3. The specimen grid holder of claim 1, wherein the first holding member has a U-shaped structure, wherein the U-shaped structure has a folded portion and two extending portions, wherein a narrowing receiving space is formed by the folded portion in defining the first inserting portion, and wherein a slender opening is formed between the two extending portions in defining the first holding portion that communicates with the receiving space.

4. The specimen grid holder of claim 1, wherein the second holding member has a U-shaped structure, wherein the U-shaped structure has a folded portion and two extending portions, wherein a narrowing receiving space is formed by the folded portion in defining the second inserting portion, and wherein a slender opening is formed between the two extending portions in defining the second holding portion that communicates with the receiving space.

5. The specimen grid holder of claim 1, wherein the first inserting portion is formed in between two first holding portions, and wherein the second inserting portion is formed in between two second holding portions.

6. The specimen grid holder of claim 1, wherein the first holding member and the second holding member are connected electrically to the base.

7. A focused ion beam system for processing semiconductor specimens, comprising:
a vacuumed chamber formed therein;
an electron source disposed in the vacuumed chamber;
a support stand disposed in the vacuumed chamber;
a specimen grid holder disposed on the support stand, comprising:
a first holding member disposed on the base, wherein the first holding member has at least one first inserting portion for inserting a specimen grid along a first rotational axis and at least one first holding portion formed adjacent to the first inserting portion, wherein the inserted specimen grid is slid to the first holding portion for securement; and
a second holding member disposed on the base, wherein the second holding member has at least one second inserting portion for inserting the specimen grid along a second rotational axis and at least one second holding portion formed adjacent to the second inserting portion, wherein the inserted specimen grid is slid to the second holding portion for securement

8. The focused ion beam system of claim 7, wherein the support stand having a plurality of rotational axes for rotation.

9. The focused ion beam system of claim 7, wherein the first holding member and the second holding member are slenderly shaped, made of conductive material, and folded backward in forming U-shaped structures, wherein each U-shaped structure has a folded portion and two extending portions, wherein a narrowing receiving space is formed by the folded portion, and wherein a slender opening that communicates with the receiving space is formed between two extending portions.

10. The focused ion beam system of claim 7, wherein the first inserting portion is formed in between two first holding portions, and wherein the second inserting portion is formed in between two second holding portions.

11. A specimen preparation method, comprising the steps of:
providing a specimen grid holder, wherein the specimen grid holder has a base, a first holding member disposed on the base and a second holding member disposed on the base, the first holding member has at least one first inserting portion and at least one first holding portion formed adjacent to the first inserting portion, the second holding member has at least one second inserting portion and at least one second holding portion formed adjacent to the second inserting portion;
providing a specimen grid secured on one of the first holding member and the second holding member;
providing a chuck attached to the specimen grid; and
thinning the chuck to reach electron transparent to produce a TEM lamella.
